(19) United States
(12) Patent Application Publication
(10) Pub. No.: US 2017/0182982 A1
(43) Pub. Date: Jun. 29, 2017

(54) JET HEATERS FOR A MOTORIZED VEHICLE

(71) Applicant: Christopher Wilkinson, Brooklyn, NY (US)

(72) Inventor: Christopher Wilkinson, Brooklyn, NY (US)

(21) Appl. No.: 15/392,666

(22) Filed: Dec. 28, 2016

Related U.S. Application Data
(60) Provisional application No. 62/272,174, filed on Dec. 29, 2015.

(51) Int. Cl. B60S 1/66; F24H 3/04; B60S 1/68

(52) U.S. Cl. CPC B60S 1/66; B60S 1/68; B60S 1/685; F24H 3/0452

(57) ABSTRACT

A system comprising a plurality of housings; a plurality of thermal heat generators: the plurality of thermal heat generators encased in the plurality of housings and adapted and configured on a plurality of oscillating fans; the plurality oscillating fans encased in the plurality of housings and adapted and configured to generate hot air. The system comprises a plurality of air jets; the plurality of air jets encased in the plurality of housings; and wherein thermal hot air produced by the plurality of oscillating fans is further propelled by the plurality of air jets; and wherein the plurality of housings comprised of a plurality of air vents and positioned on the undercarriage of a motorized vehicle; and wherein thermal hot air is forced out of the plurality of air vents onto snow or ice located under a motorized vehicle.

### CLAIM OF PRIORITY

This application claims the priority of U.S. Ser. No. 62/272,174 filed on Dec. 29, 2015, the contents of which are fully incorporated herein by reference.

### FIELD OF THE EMBODIMENTS

The invention and its embodiments relate to a system, method and device for eliminating the hazardous conditions present under a motor vehicle during a snow or ice storm. The invention discloses novel methods relating to the undercarriage of a vehicle.

### BACKGROUND OF THE EMBODIMENTS

Snow, ice and sleet are consistently and forever getting stuck under a person's vehicle. Whether the vehicle is a car or truck or motorcycle, a motorized vehicles tires can get stuck or immobile when faced with such hazardous weather conditions. A person must, if able to, exit their car and either shovel the snow or sleet away. This makes more an even more hazardous condition as these events often happen on busy road and streets during the actual storm that caused the condition in the first place. Such events do not occur in the safety of ones driveway where the problem can actually be viewed as potentially more difficult since when home riding out a storm, ones vehicle is parked and the accumulation of snow and ultimately ice becomes abundant since the snow remains untouched and which has not been shoveled. The present invention seeks to solve this problem.

### REVIEW OF RELATED TECHNOLOGY

U.S. Pat. No. 6,946,621 teaches an automotive vehicle safety device for melting ice and snow on roadways and in areas immediately adjacent the vehicle tires includes ductwork extending from a heater mounted adjacent the vehicle engine with the ductwork terminating at front and rear undercarriage mounted v-shaped ducts. Each v-shaped duct includes a pair of heating vents disposed adjacent each vehicle tire that blows heated air onto the roadway for melting the ice and snow. A heating grid is securable to the vehicle undercarriage for providing additional radiant heat to melt ice and snow, and a dashboard-mounted control panel provides for the manual activation of the heater and the heating grid while sensors mounted to the undercarriage and electrically connected to the control panel provide for automatic activation of the heater and heating grid upon sensing a predetermined temperature.

U.S. Pat. No. 4,202,423 teaches a device for diverting exhaust gases from the engine of a vehicle such as an automobile to opposite tread surfaces of the driving wheel tires thereof. The device includes a valve assembly having a body interconnected to the vehicle exhaust system, conduits for diverting the above-indicated gas flow being joined to the body and extending outwardly therefrom. A valve member in the form of a pivoted plate is located within the body and is manually operated to divert the exhaust gases into the conduits for discharge at the driving wheels of the vehicle. The device is useful in removing ice or snow from the driving wheels as well as preventing hydroplaning thereof in wet weather.

U.S. Patent Publication No. 20030141289 discloses a heated underside apparatus which removes snow/icy mass buildup from motor vehicles. The invention comprises panel sections located along the lateral peripheral sides of an automobile as well as along the front and back periphery, along the bumpers. The panel sections are comprised of a heating element embedded in a thermally conductive material which radiates thermal energy. The heated underside apparatus is adapted such that it is powered by the power source of the vehicle, i.e., the battery, or an auxiliary power supply operatively connected to the vehicle. In a preferred embodiment of the present invention, the apparatus comprises a feedback system which operates by real time monitoring of temperature and moisture levels to thereby maintain threshold levels above freezing point until the snow/icy mass buildup is removed.

U.S. Pat. No. 4,324,307 discloses an improved ice and snow melting system employing motor vehicle hot exhaust gases includes a stub pipe for bolt-on clamping to the rear of a motor vehicle exhaust pipe in parallel-spaced relation, in forward direction the stub pipe divides in a “Y” shaped configuration; from each arm of the “Y” a flexible tube leads forward and outward to a portion adjustable to heat a vehicle drive wheel and road surface traction area; for valving hot gases from the motor vehicle exhaust into the system a flexible tube is applied in “U” shape and through frictional fit to connect the rear of the vehicle exhaust pipe with the stub-tube; when not in use the flexible tube may be removed and stored in the trunk of the motor vehicle.

U.S. Pat. No. 7,693,630 discloses a snow melting system for heating a vehicle to melt snow and ice from an exterior of the vehicle includes a vehicle. A power supply is positioned in the vehicle. Each of a plurality of heating elements extends through a portion of an exterior surface of the vehicle. Each of the heating elements is electrically coupled to the power supply. The power supply supplies power to the heating elements to heat the heating elements to melt ice and snow from the exterior surface of the vehicle.

U.S. Pat. No. 8,573,505 discloses a method of heating an undercarriage of a machine featuring obtaining a thawing system with a hydraulic system functioning to heat hydraulic fluid and a first high pressure line and a second high pressure line each fluidly connected to the hydraulic system and each adapted to carry hydraulic fluid from the hydraulic system; operatively connecting the hydraulic system to a main engine of the machine; creating channels in the machine to allow passage of the first high pressure line and the second high pressure line from the hydraulic system to the undercarriage of the machine; and activating the system, wherein when the system is activated the hydraulic fluid is delivered to the undercarriage providing heat to the undercarriage for thawing purposes.

U.S. Pat. No. 5,897,802 teaches a heated debris shield apparatus, comprising a body, a heating element connected to the body, and a means for controlling the supply of power to the heating element. U.S. Pat. No. 5,573,686 teaches a multipurpose wheel well apparatus is provided for a wheel well in a quarter panel of a motor vehicle which consists of a structure for protecting the wheel well from stone, salt and moisture damage. A mechanism is provided for securing the protecting structure within the wheel well of the motor vehicle, so that the wheel well will resist impacts, stress and corrosion. A second mechanism is provided for supplying light and radiant heat to the wheel well for the purpose of assisting a motorist in changing a flat tire and for the purpose of melting ice and snow in the wheel well and in the tire treads of the vehicle.

U.S. Pat. No. 6,021,843 discloses a device for melting snow and ice in the wheel wells of a motor vehicle. The device comprises tubing which extends from the radiator of the vehicle to the wheel wells in a continuous loop. When the device is activated by an on-off switch inside the vehicle, warm fluids are circulated through the tubing to melt the ice and snow in the wheel wells.

Various devices are known in the art. However, their structure and means of operation are substantially different from the present invention. Such devices fail to provide a device that is optimized for non-infant children, fail to enhance the child's imagination, which is capable of being used as a nap retraining device. At least one embodiment of this invention is presented in the drawings below, and will be described in more detail herein.

### SUMMARY OF THE EMBODIMENTS

A system comprising a plurality of housings; a plurality of thermal heat generators: said plurality of thermal heat generators encased in the plurality of housings and adapted and configured on a plurality of oscillating fans; said plurality oscillating fans encased in the plurality of housings and adapted and configured to generate hot air. The system comprises a plurality of air jets; said plurality of air jets encased in the plurality of housings; and wherein thermal hot air produced by the plurality of oscillating fans is further propelled by the plurality of air jets; and wherein said plurality of housings comprised of a plurality of air vents and positioned on the undercarriage of a motorized vehicle; and wherein thermal hot air is forced out of the plurality of air vents onto snow or ice located under a motorized vehicle.

The system also comprises vents which are located directly over a motorized vehicles tires wherein the direction of the vents is adjustable. The temperature of the air is adjustable and the speed of the plurality of thermal heating oscillating fans is adjustable. The speed of the plurality air jets is adjustable. The system comprises software to control the speed of the plurality of thermal heating oscillating fans. The software also controls the speed of the plurality of air jets. The software can control the direction of the plurality of air vents. The software may be an internal component of the motorized vehicle. The motorized vehicle may be a car, tractor, truck or motorcycle. The software may be downloaded onto a mobile device.

It is an object of the present invention where the plurality of air vents may be positioned over each tire of the motorized vehicle.

It is an object of the present invention where the plurality of housings are distributed in a customizable configuration on the undercarriage of a motorized vehicle.

It is an object of the present invention where comprises a plurality of cameras which may be used to detect the snow and ice conditions under the motorized vehicle.

It is an object of the present invention where a plurality of sensor which may be used to detect the snow and ice conditions under the motorized vehicle.

It is an object of the present invention wherein the plurality of thermal heating oscillating fans are sized to be integrated into the undercarriage of an automobile.

### BRIEF DESCRIPTION OF THE DRAWINGS

FIG. 1 shows an illustrative view of a bottom view of the present invention.

FIG. 2 shows an illustrative view of a side view of the present invention.

FIG. 3 shows an alternative embodiment of a bottom view of the present invention.

### DESCRIPTION OF THE PREFERRED EMBODIMENTS

The preferred embodiments of the present invention will now be described with reference to the drawings. Identical elements in the various Figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

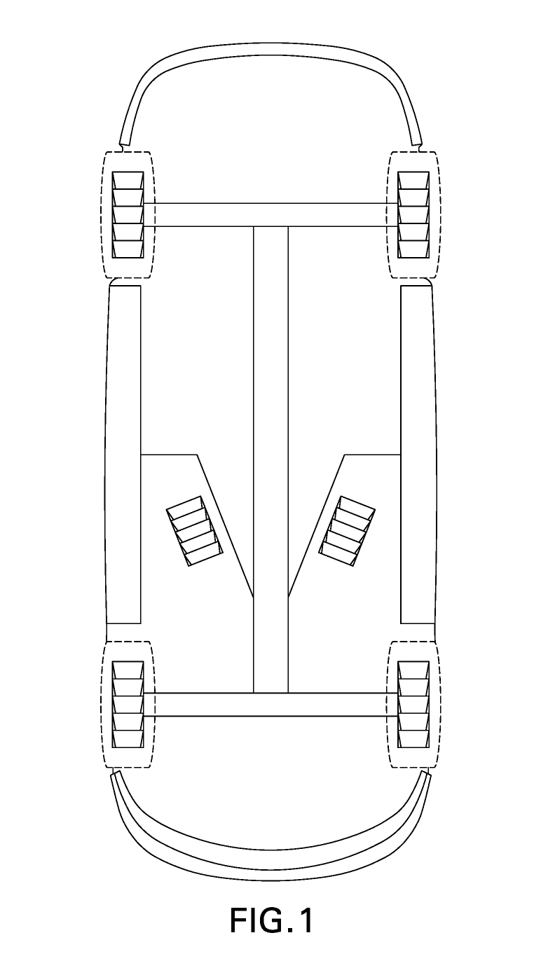

FIG. 1 shows the undercarriage of a motorized vehicle. In this preferred embodiment a car is shown. However in other embodiments of the present invention the motorized vehicle maybe a tractor or truck. In another embodiment a motorcycle may be equipped with the present invention. In FIG. 1 multiple housing units are shown. Each housing unit is comprised of vents. Such vents are positioned over a vehicles tires where snow and ice may be accumulated and which causes the vehicle to not move and possess no traction. In FIG. 1 multiple housings are also positioned near the center rear and front of a vehicle also where snow and ice may have caused the vehicles tires to be stuck.

Such housings contain a plurality of thermal heat generators which produce heat. The housings also contain oscillating fans which when spinning create air. Such air is heated up by the thermal heat generators. Such hot air is then blown by a plurality of air jets at a fast speed out of the vents in the direction of the snow and ice that may be over and above a car tires. The present invention also includes a mobile application or car application wherein a user is notified of snow or ice has been accumulated and a graphical user interface wherein the user can detect and see where under the vehicle is the snow or ice that is preventing traction and movement. Once detected a user may move the direction of the vents over the tires to point directly onto the snow or ice causing the problem. In addition the user may speed up the oscillating fans to produce faster air. The user may also increase of decease the temperature of the heat generator such that the thermal Hot air created is at a high enough temperature to melt the thickest of ice during the coldest of outside temperature conditions.

In another embodiment the software used by the user or by the internal motorized vehicles computer system may be enabled with sensors that can automatically detect a snow or ice condition. Such conditions may cause the system to initiate q cycle of hot air to be directed to improve the movement or traction of the vehicles tires.

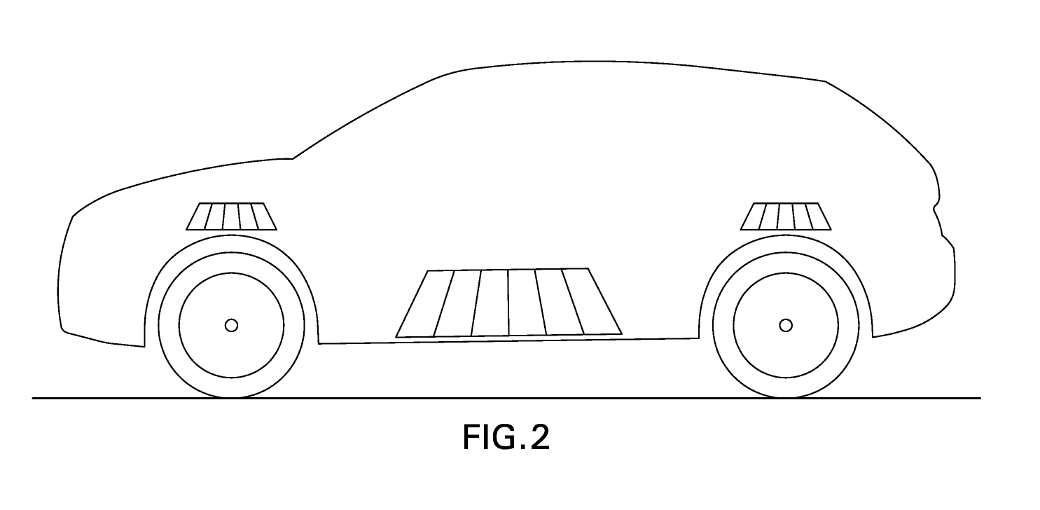

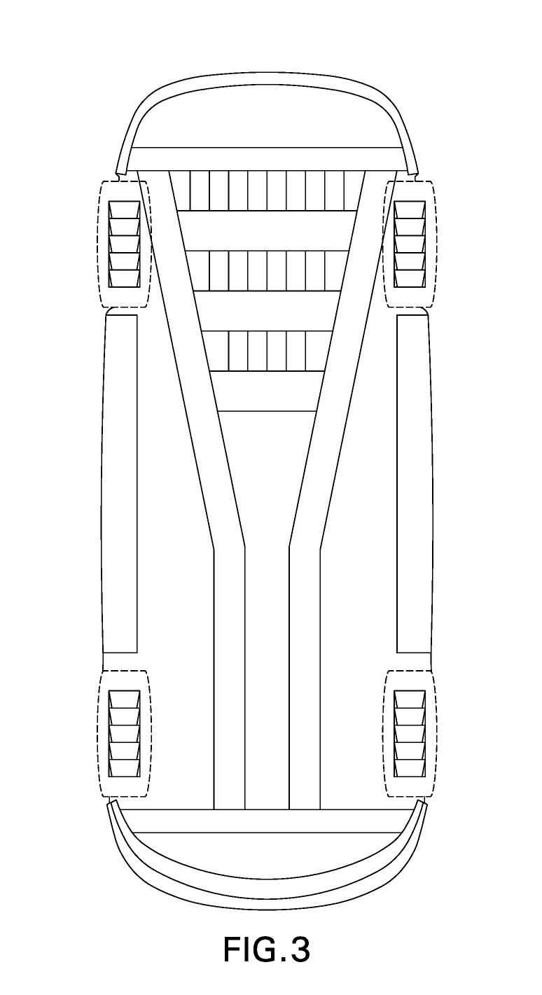

FIG. 2 shows a side view of motorized vehicle wherein the housings and vents are positioned directly over the tires. FIG. 3 shows an alternative embodiment of the present invention. FIG. 3 shows a system of hydraulic lifts that may be used to lift a vehicle out of quicksand. Such hydraulic lifts can be controlled by the driver or a user of mobile application having the present inventions software. The user can increase or decrease the elevation of the hydraulic lifts defending on the situation presenting itself. In another embodiment the car can be lifted out of sand or water or mud. The hydraulic lifts may directly affect the weight distribution of the vehicle to enable the vehicle to move. The hydraulic lifts can lift the car as high as 12 inches.

In another embodiment the motor vehicle may be equipped with tires that can be deflated or inflated by a user via a mobile application or internal car application. The deflating or inflating of a car tire may enable a driver to adjust the vehicles weight distribution to allow it to move out of a situation where the motor vehicle cannot move. The tires can be also deflated to lower the vehicle by as low as 1-3 inches and inflated to raise the car by 1-3 inches.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A system for creating thermal hot air to melt a hazardous snow condition, comprising:
memory that stores computer-executable instructions; said computer-executable instructions;
a processor, communicatively coupled to the memory that facilitates execution of the computer-executable instructions; said instructions comprising:
a plurality of housings;
a plurality of thermal heat generators: said plurality of thermal heat generators encased in the plurality of housings and adapted and configured on a plurality of oscillating fans; said plurality oscillating fans encased in the plurality of housings and adapted and configured to generate hot air;
a plurality of air jets; said plurality of air jets encased in the plurality of housings; and
wherein thermal hot air produced by the plurality of oscillating fans is further propelled by the plurality of air jets; and
wherein a said plurality of housings comprised of a plurality of air vents and positioned on the undercarriage of a motorized vehicle; and
wherein thermal hot air is forced out of the plurality of air vents onto snow or ice located under a motorized vehicle.

2. The system of claim 1, wherein the vents are located directly over a motorized vehicles tires.

3. The system of claim 1, wherein the direction of the vents is adjustable.

4. The system of claim 1, wherein the temperature of the air is adjustable.

5. The system of claim 1, wherein the speed of the plurality of thermal heating oscillating fans is adjustable.

6. The system of claim 1, wherein the speed of the plurality of air jets is adjustable.

7. The system of claim 1, further comprising software to control the speed of the plurality of thermal heating oscillating fans.

8. The system of claim 1, further comprising software to control the speed of the plurality of air jets.

9. The system of claim 1, further comprising software to control the direction of the plurality of air vents.

10. The system of claim 1, further comprising software which is an internal component of the motorized vehicle.

11. The system of claim 1, wherein the motorized vehicle may be a car, tractor, truck or motorcycle.

12. The system of claim 1, wherein the plurality of air vents may be positioned over each tire of the motorized vehicle.

13. The system of claim 1, wherein the software can be downloaded onto a mobile device.

14. The system of claim 1, wherein the plurality of thermal heating oscillating fans are sized to be integrated into the undercarriage of an automobile.

15. The system of claim 1, wherein the plurality of housings are distributed in a customizable configuration on the undercarriage of a motorized vehicle.

16. The system of claim 1, wherein a plurality of cameras are used to detect the snow and ice conditions under the motorized vehicle.

17. The system of claim 1, wherein a plurality of sensor are used to detect the snow and ice conditions under the motorized vehicle.
